(19) United States
(12) Patent Application Publication
(10) Pub. No.: US 2026/0331974 A1
(43) Pub. Date: Oct. 22, 2026

(54) ROTOR OF AN ELECTRIC MACHINE

(71) Applicant: Robert Bosch GmbH, Stuttgart (DE)

(72) Inventors: Gerald Strobel, Oberasbach (DE); Christoph Leisen, Forchheim (DE); Stefan Zaensch, Stein (DE)

(21) Appl. No.: 19/111,417

(22) PCT Filed: Jul. 24, 2023
(86) PCT No.: PCT/EP2023/070447

§ 371 Date: Mar. 13, 2025

(30) Foreign Application Priority Data
Sep. 19, 2022 (DE) 10 2022 209 824.2

(51) Int. Cl. H02K 1/24; H02K 3/18; H02K 3/52; H02K 19/02

(52) U.S. Cl. CPC H02K 1/24; H02K 3/18; H02K 3/527; H02K 19/02; H02K 2203/12

(57) ABSTRACT

Rotor (1) of an electric machine having a rotor axis (2) and a plurality of leg poles (3) arranged along a circumferential direction of the rotor (1), between which pole grooves (4) are formed for arranging electrical conductors of a rotor winding (5), wherein the leg poles (3) have pole shoes (6) on the radially outer pole end, wherein the leg poles (3) are each enclosed by a coil (7) of the rotor winding (5), wherein each coil (7) comprises two coil groove sections (7n) extending into pole grooves (4) and a plurality of winding layers (8), characterized in that in the coil groove sections (7n) of the respective coil (7) between an uppermost and a lowermost winding layer (8), respectively, a winding panel (10) is provided, the outer side facing away from the respective leg pole (3) comprising a plurality of support ribs (11) for forming winding chambers (12), and in particular being made of plastic, and that lower winding layers of the respective bobbin (7) are provided below the two winding plates (10) and upper winding layers of the respective coil (7) in the winding chambers (12) above the two winding plates (10).

### BACKGROUND

The invention proceeds from a rotor of an electric machine of the type specified in the disclosure.

A rotor of an electric machine is already known from JP9215240 A2, having a rotor axis and a plurality of leg poles disposed along a circumferential direction of the rotor, between which pole grooves are formed for arranging electrical conductors of a rotor winding, wherein the leg poles have pole shoes on the radially outer pole ends, wherein the leg poles are each surrounded by a coil, in particular a single coil, of the rotor winding, wherein each coil comprises two coil groove sections extending into pole grooves and a plurality of winding layers.

### SUMMARY

In contrast, the rotor of an electric machine according to the invention has the advantage that the coils in the upper winding layers are arranged in an orderly manner and are better supported in terms of a rotational speed load. In lower winding layers of the respective coil, due to a rectangular coil cross-section, no support ribs are required for orderly winding, so that a particularly high filling factor, in particular a copper filling factor, is achievable in the pole grooves due to the lack of support ribs therein.

This is achieved according to the invention in that a winding plate is provided in the coil groove sections of the respective coil between an uppermost and a lowermost winding layer, comprising a plurality of support ribs on an outer side facing away from the respective leg pole for forming winding chambers, and in particular consisting of plastic, and in that lower winding layers of the respective coil below the two winding plates and upper winding layers of the respective coil are provided in the winding chambers above the two winding plates.

It is particularly advantageous if a circumferentially measured height of the support ribs of the respective winding plate increases radially outward relative to the rotor axis. In this way, orderly winding can be achieved in the upper winding layers of the respective coil deviating from the rectangular shape, for example having a trapezoidal or triangular coil cross-section, whereby a particularly high filling factor can be achieved in the pole grooves. In particular, the coil with the upper winding layers in the circumferential direction of the rotor can extend beyond the respective pole shoe.

It is further advantageous if a sleeve-shaped plastic coil carrier is provided on each leg pole, on which a coil receptacle for receiving the respective coil is formed. In this way, the coils of the rotor winding are electrically insulated from the leg poles. Additionally, insulating components, for example an insulating paper, are not required.

It is highly advantageous if the coil receptacle is formed along a receptacle base of the coil carrier between two ring collars of the coil carrier. In this way, the respective coil can be received between the collars.

It is also advantageous if the winding plates are attached to the respective coil carrier, in particular to the ring collar, or directly to the respective leg pole, in particular in a positive locking and/or in a frictional and/or bonded manner. In this way, the support ribs of the winding plates can absorb speed loads.

Furthermore, is advantageous if at least one groove-shaped profile is respectively configured at the receptacle base of the respective coil carrier and/or at a base of the winding chambers for aligning the windings of the respective coil. In this way, the lowermost layer of the lower winding layers and the lowermost layer in the upper winding layers can be precisely positioned, so that a high filling factor and a symmetrical or orderly winding pattern can be achieved in the pole grooves.

The winding plates advantageously each extend within the respective pole groove in the axial direction with respect to the rotor axis and are spaced apart from a flank side of the respective leg pole. The winding plates are provided exclusively in the pole grooves and expressly do not extend into the winding head area.

It is advantageous if a groove slot is configured as a radial opening of the respective pole groove between each pair of adjacent pole shoes, wherein a groove fastener is respectively provided in each of the groove slots. In this way, the rotor winding can additionally be supported against incident centrifugal forces.

According to one advantageous exemplary embodiment, the leg poles may be separate bodies attached to a pole carrier, in particular to a rotor shaft, in particular in a friction-locking or positive-locking manner. In this way, a particularly high conductor filling factor, in particular copper filling factor, can be achieved in the rotor grooves.

Alternatively, the leg poles may be integrally connected to a rotor yoke to form a rotor sheet package, wherein the pole shoes are separate bodies that are secured to the leg poles in a positive-locking manner.

Furthermore, the invention relates to an electric machine comprising a rotor according to the invention.

### BRIEF DESCRIPTION OF THE DRAWINGS

An exemplary embodiment of the invention is shown in simplified form in the drawing and explained in more detail in the following description.

Shown are:

FIG. 1 a partial sectional view of a rotor with leg poles according to the invention,

FIG. 2 one of the leg poles according to the invention according to FIG. 1, and

FIG. 3 the leg pole according to FIG. 2 in a further view.

### DETAILED DESCRIPTION

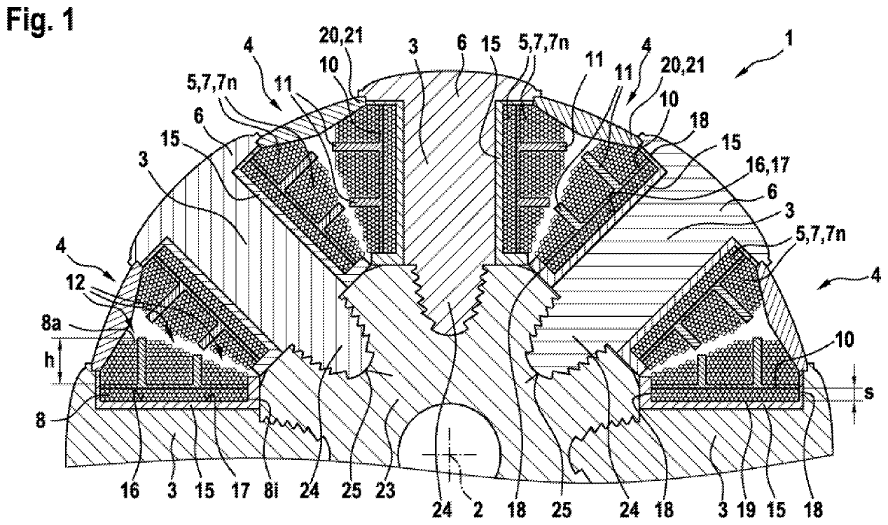

FIG. 1 shows a sectional partial view of a rotor with leg poles according to the invention.

The rotor 1 of an electric machine according to the invention, for example an electrically excited synchronous machine, is rotatable about a rotor axis 2 and comprises a plurality of leg poles 3 arranged along a circumferential direction of the rotor 1, between which pole grooves 4 are formed for the arrangement of electrical conductors of a rotor winding 5. The leg poles 3 have pole shoes 6 on the pole ends radially outward to the rotor axis 2. The leg poles 3 are each enclosed by a coil 7, in particular a single coil, of the rotor winding 5. Each coil 7 has two coil groove sections 7n that run in pole grooves 4 and two coil winding head sections that run outside of the pole grooves 4. In addition, each coil 7 has a plurality of winding layers 8.

According to the invention, it is provided that in the coil groove sections 7n of the respective coil 7, between an uppermost 8 a and a lowermost 8i winding layer 8, a winding plate 10 is provided, which comprises a plurality of support ribs 11 on an outer side facing away from the respective leg pole 3, for forming winding chambers 12 and in particular consists of plastic. In addition, according to the present invention, it is provided that lower winding layers 8 of the respective coil 7 are provided below the two winding plates 10 of the respective leg pole 3 and upper winding layers 8 of the respective coil 7 in the winding chambers 12 above the two winding plates 10.

A circumferentially measured height h of the support ribs 11 of the respective winding plate 10 can increase radially outward relative to the rotor axis 2.

At each leg pole 3, for example, a sleeve-shaped coil carrier 15 made of plastic is provided, on which a coil receptacle 16 is formed for receiving the respective coil 7. The coil carrier 15 is, for example, injection-molded or cast onto the respective leg pole 3. The coil receptacle 16 may be formed along a receptacle base 17 of the coil carrier 15 between two ring collars 18 of the coil carrier 15.

The winding plates 10 may be attached to the respective coil carrier 15, in particular to the ring collar 18, or directly to the respective leg pole 3, for example, in a positive locking and/or in a frictional and/or bonded manner.

A groove slot 20 is respectively configured, for example, between each pair of neighboring pole shoes 6 as a radial opening of the respective pole groove 4, wherein a groove fastener 21 is respectively arranged in each of the groove slots 20.

According to the exemplary embodiment, the leg poles 3 are separate bodies that are attached to a pole carrier 23, in particular to a rotor shaft, in particular in positive locking and/or friction locking manner. Alternatively, the leg poles 3 can also be integrally connected to a rotor yoke to form a rotor plate package and the pole shoes 6 can be separate bodies that are fixed to the leg poles 3 in a positive-locking manner. According to the exemplary embodiment, the leg poles 3 each have a pole anchor 24, wherein the pole anchors 24 of the leg poles 3 are insertable in the axial direction with respect to the rotor axis 2 in anchoring grooves 25 of the pole carrier 23.

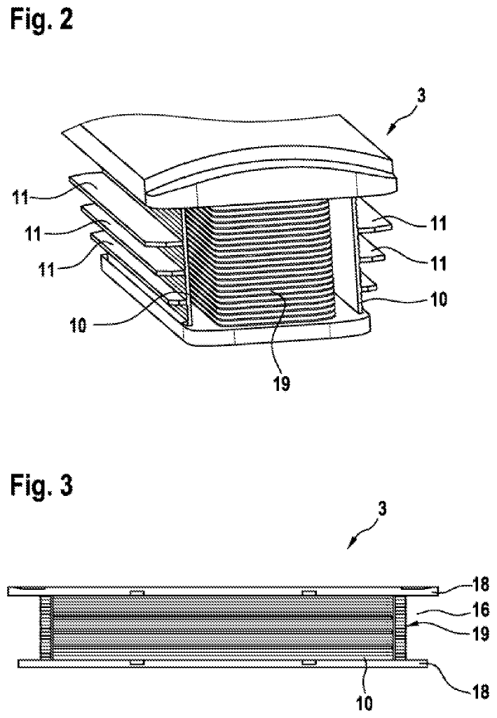

FIG. 2 shows one of the leg poles according to the invention pursuant to FIG. 1 without the respective coil 7. FIG. 3 shows the leg pole of FIG. 2 in a further view.

The winding plates 10 each extend within the respective pole groove 4 in the axial direction with respect to the rotor axis 2 and each have a distance s to a flank side of the respective leg pole 3. The winding plates 10 are each arranged parallel to the respective flank side of the respective leg pole 3, for example.

At the receptacle base 17 of the respective coil carrier 15 and/or at a base of the winding chambers 12, a groove-shaped profile 19 can be configured across the entire circumference or in circumferential sections to align the windings of the respective coil 7.

1. A rotor (1) of an electric machine having a rotor axis (2) and a plurality of leg poles (3) arranged along a circumferential direction of the rotor (1), between which pole grooves (4) are formed for arranging electrical conductors of a rotor winding (5), wherein the leg poles (3) have pole shoes (6) on radially outer pole ends, wherein the leg poles (3) are each surrounded by a coil (7) of the rotor winding (5), wherein each coil (7) comprises two coil groove sections (7n) extending into pole grooves (4) and a plurality of winding layers (8),
wherein
in the coil groove sections (7n) of the respective coil (7), a winding plate (10) is provided between an uppermost (8a) and a lowermost (8i) winding layer (8), respectively, an outer side of the winding plate (10) facing away from the respective leg pole (3) comprising a plurality of support ribs (11) for forming winding chambers (12) and wherein lower winding layers of the respective coil (7) are provided below the two winding plates (10) and upper winding layers of the respective coil (7) in the winding chambers (12) above the two winding plates (10).

2. The rotor according to claim 1, wherein a height (h) of the support ribs (11) of the respective winding plate (10) measured in the circumferential direction increases radially outward relative to the rotor axis (2).

3. The rotor according to claim 1, wherein a sleeve-shaped coil carrier (15) made of plastic is provided at each leg pole (3), on which a coil receptacle (16) is configured for receiving the respective coil (7).

4. The rotor according to claim 3, wherein the coil receptacle (16) is formed along a receptacle base (17) of the coil carrier (15) between two ring collars (18) of the coil carrier (15).

5. The rotor according to claim 3, wherein the winding plates (10) are attached to the respective coil carrier (15) or directly to the respective leg pole (3).

6. The rotor according to claim 3, wherein at least one groove-shaped profile is respectively configured at the receptacle base (17) of the respective coil carrier (15) and/or at a base of the winding chambers (12) for aligning the windings of the respective coil (7).

7. The rotor according to claim 1, wherein the winding plates (10) each extend within the respective pole groove (4) in an axial direction with respect to the rotor axis (2) and have a distance(s) to a flank side of the respective leg pole (3).

8. The rotor according to claim 1, wherein a groove slot (20) is respectively configured as a radial opening of the respective pole groove (4) between each pair of adjacent pole shoes (6), wherein a groove fastener (21) is respectively provided in each of the groove slots (20).

9. The rotor according to claim 1, wherein
a. the leg poles (3) are separate bodies attached to a pole support (23), or
b. the leg poles (3) are integrally connected to a rotor yoke to form a rotor plate package, wherein the pole shoes (6) are separate bodies fixed to the leg poles (3) in a positive-locking manner.

10. An electric machine with a rotor (1) according to claim 1.

11. The rotor according to claim 1, wherein the electric machine is an electrically excited synchronous machine.

12. The rotor according to claim 1, wherein the leg poles (3) are each surrounded by a single coil (7).

13. The rotor according to claim 1, wherein the winding plate (10) comprises plastic.

14. The rotor according to claim 5, wherein the winding plates (10) are attached to a ring collar (18) of the respective coil carrier (15).

15. The rotor according to claim 5, wherein the winding plates (10) are attached to the respective coil carrier (15) or directly to the respective leg pole (3) in positive-locking and/or in a friction-locking manner and/or in a bonded manner.

16. The rotor according to claim 9, wherein the leg poles (3) are separate bodies attached to a rotor shaft.

17. The rotor according to claim 9, wherein the leg poles (3) are separate bodies attached to the pole support (23) in a positive-locking and/or friction-locking manner.
